(19) United States
(12) Patent Application Publication
(10) Pub. No.: US 2010/0235827 A1
(43) Pub. Date: Sep. 16, 2010

(54) Creation of multiple radio instances

(75) Inventor: Pasi Rinne-Rahkola, Helsinki (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/381,404

(22) Filed: Mar. 10, 2009

(51) Int. Cl. G06F 9/445

(52) U.S. Cl. 717/174

(57) ABSTRACT

In a first aspect an exemplary embodiment of the invention provides an apparatus that includes a memory; a hardware unit embodying at least a portion of a radio physical layer; and a controller configured to install a radio system package into the memory, to respond to a first request to load a new radio system instance of the installed radio system package and to respond to a second request to activate the loaded radio system instance and to execute the loaded radio system instance using the hardware unit. The controller is further configured to execute a plurality of radio system instances of the same radio system package or different radio system packages with the hardware unit so that a portion of physical layer resources are shared in a non-interfering manner between the radio system instances. The exemplary embodiments may be embodied in a software defined radio having a multiple radio controller.

### TECHNICAL FIELD

The exemplary and non-limiting embodiments of this invention relate generally to wireless communication systems, methods, devices and computer programs and, more specifically, relate to multi-radio technology, multi-radio scheduling and software defined radio (SDR).

### BACKGROUND

The following abbreviations are utilized herein:

3GPP third generation partnership project

CM configuration manager

RM resource manager

GSM global system for mobile communications

HSDPA high speed downlink packet access

MAC medium access control

MRC multiradio controller

RF radio frequency

SDR software defined radio

SIM subscriber identity module

WLAN wireless local area network (e.g., IEEE 802.11 family)

Traditionally, a radio access protocol stack has been a single entity with a top level control interface and dedicated hardware resources. Having two instances of the same radio system in the same device has not been feasible in a practical sense, as this would require that two instances of all of the hardware and software resources be present.

It is recognized that some radio standards allow decoupling of the physical layer (PHY) and the protocols part (layers above PHY, such as the MAC). This may be used to share the same physical layer implementation between variants of one radio standard, or even across multiple standards. GSM and 3G resource sharing is one example, wherein the radio systems may utilize many of the same hardware resources efficiently since their standardization is coordinated in the same standardization body. This only allows, however, utilizing different radio access technologies to obtain access to the wireless cellular network, one technology at a time.

### SUMMARY

The foregoing and other problems are overcome, and other advantages are realized, by the use of the exemplary embodiments of this invention.

In a first aspect thereof the exemplary embodiments of this invention provide a method comprising installing a radio system package; in response to a first request, loading a new radio system instance of the installed radio system package; and in response to a second request, activating the loaded radio system instance and executing the loaded radio system instance.

In another exemplary embodiment of the invention, there is a memory storing a program of computer readable instructions that when executed by a processor result in actions that comprise installing a radio system package; in response to a first request, loading a new radio system instance of the installed radio system package; and in response to a second request, activating the loaded radio system instance and executing the loaded radio system instance.

In yet another exemplary embodiment of the invention, an apparatus comprises a memory; a hardware unit embodying at least a portion of a radio physical layer; and a controller configured to install a radio system package into said memory, to respond to a first request to load a new radio system instance of the installed radio system package and to respond to a second request to activate the loaded radio system instance and to execute the loaded radio system instance using said hardware unit.

### BRIEF DESCRIPTION OF THE DRAWINGS

In the attached Drawing Figures:

FIG. 1 is a class diagram of an SDR system.

FIG. 2 is an object diagram of the SDR with a GSM system instantiated.

FIG. 3 is an object diagram of the SDR with two instances of the GSM system.

FIG. 4 is a class diagram of the contents of a radio protocol stack.

FIG. 5 is an object diagram showing instances of protocol stack elements when two GSM systems are instantiated.

FIG. 6 depicts an exemplary embodiment of a SDR device, such as a multimode cellular phone or other type of communication device.

FIG. 7 depicts a logic flow diagram that illustrates the operation of a method, and the execution of computer program code, in accordance with embodiments described in PCT/IB2008/055522.

FIG. 8A shows a non-limiting example of a radio system package and its contents.

FIG. 8B shows an example of the creation (by a load operation) of i radio system instances from the radio system package of FIG. 8A.

FIG. 9 depicts states and state transitions of the radio system package and an instance of the radio system package during their respective life-cycles.

FIG. 10 is a simplified block diagram of software defined radio components, including a configuration manager, a resource manager, and a radio system execution environment in accordance with an exemplary aspect of the embodiments of this invention.

FIG. 11 is a simplified block diagram of the configuration manager of FIG. 10 in accordance with an exemplary aspect of the embodiments of this invention.

FIG. 12 depicts a logic flow diagram that illustrates the operation of a method, and the execution of computer program code, in accordance with the exemplary embodiments of this invention.

### DETAILED DESCRIPTION

As used herein SDR is assumed to encompass a radio computer that is capable of running concurrent radio systems on top of shared hardware resources. This differs from a “traditional” software controlled radio which typically use dedicated hardware resources, rather than shared resources, or where the resource sharing is very limited and subject to the applicable (and similar) radio standards (e.g., GSM/3G sharing the same RF signal path).

In the SDR in accordance with exemplary embodiments of this invention radio systems may be realized using software components running on one processor, or more than one different types of processors (e.g., general purpose, signal processing, vector processing), in addition to suitable hardware components to accommodate those functions that cannot be implemented (or are too inefficient to implement) with software. In this type of system it is possible to instantiate a single radio system two or more times. The two (or more) instances of the same radio system may utilize the same hardware resources (processing power and hardware components), and a MRC grants air access time (e.g., wireless cellular access) to the plurality of instances.

Of particular interest herein is a multi-radio system described in copending International Patent Application PCT/IB2008/055522, “Multiple Radio Instances Using Software Defined Radio”, Antti-Veikko S. Piipponen, Kalle A. Raiskila, Pasi J. Rinne-Rahkola. Tommi J. Zetterman and Heikki I. Berg, incorporated by reference herein in its entirety. PCT/IB2008/055522 describes techniques to have multiple instances of the same radio system executing simultaneously in a SDR system.

A consideration that arises in such a system relates to the creation of the instances of same radio system, and related considerations such as what is the life-cycle of each such instance, and how meta-data and parameters for each instance are managed. In a non-SDR radio implementation these considerations do not arise since each radio is basically a separate fixed hardware and software entity.

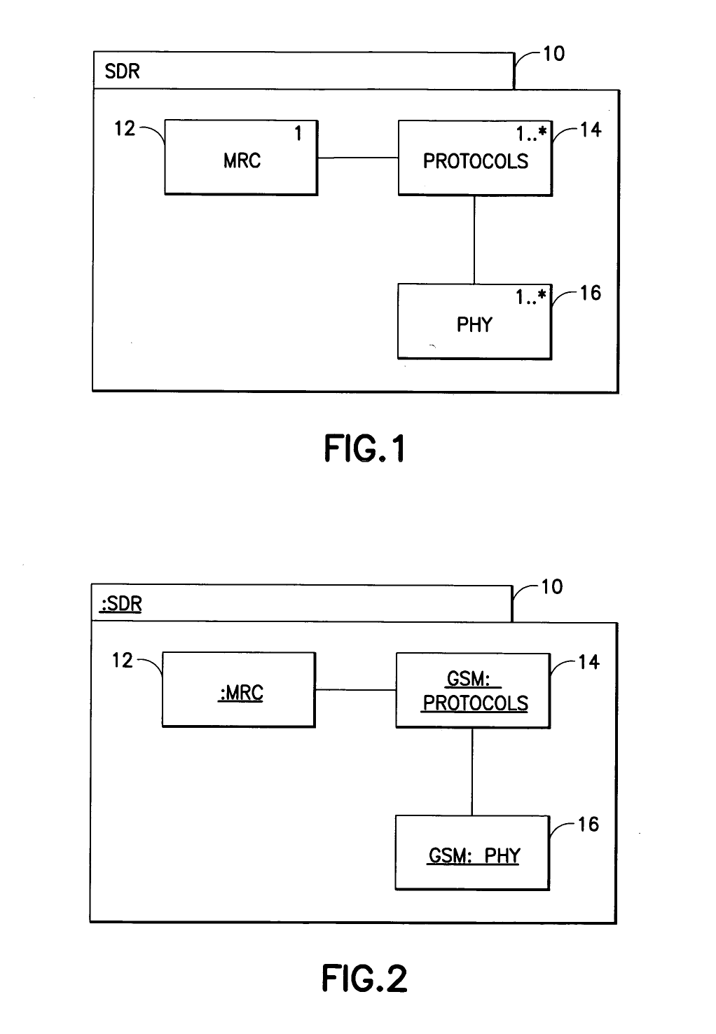

Before describing in detail the exemplary embodiments of this invention, the SDR system described in the above-referenced PCT/IB2008/055522 will be briefly described with reference to FIGS. 1-7. Note that the SDR system described in PCT/IB2008/055522 is but one non-limiting example of a SDR system in which the exemplary embodiments of this invention may be implemented and practiced.

The utility of the various embodiments described in PCT/IB2008/055522 may be explained at least in part via the following exemplary use cases.

Use Case A: A cellular phone participates in multiple wireless networks at the same time. This type of operation may imply that the phone user has two SIM cards, or a dual SIM (e.g., work and private subscriptions), and that the phone is simultaneously connected using both subscriber connections. From the wireless network perspective this appears as two separate and distinct user equipment. The cellular radios typically have a low duty cycle when in the idle mode and as a result wireless access is virtually guaranteed for each connection until there is activity, e.g., a phone call. When one connection is active, the other connection(s) are either dropped from the network, or an intelligent schedule is provided so that they can occasionally receive a few (idle state) messages from the base station.

This use case assumes that the separate protocol instances may share some hardware accelerators or other signal processing blocks in a time-sliced manner (scheduling provided, for example, using the MRC), which is described in greater detail below. In an exemplary implementation the dedicated (shared) components reside mainly at the RF front end. If one GSM subscriber connection is moved to the GSM 1800 MHz band, and the other operates on the GSM 900 MHz band, the protocol instances may cooperate more freely and the connection to the base station maybe kept alive during a phone call. The separate radio instance in this case is truly separate, and any coexistence operational approach may be handled at the phone's user interface level.

Use Case B: This use case involves a dual WLAN for routing between two WLAN networks. A (mobile) station is able to participate in two networks using time sharing; a concrete use case is participating both to an infrastructure network and an adhoc network simultaneously. This type of behavior may be applicable to other radio technologies as well.

Use Case C: This use case involves support for nonstandard measurements/activities. Assume that although a radio system is activated and operating according to a standard, it may not be able to provide the radio user with “cognitivity” information. For example, a cellular radio may not be dictated by the applicable standard to scan for other networks (other than the current operator's network). This can be overcome by instantiating another cellular radio, and thereby freely scanning for another network or networks using the newly instantiated cellular radio. This assumes that the scanning can be scheduled at those times not used by the first radio instance.

Use Case D: This use case provides support for multiple types of radio “users”, e.g., an administrator user, a field test user, a factory test user, an end user and a SIM-locked end user. As the entire radio instance may be duplicated for each user type, it is possible to give different types of access rights to the radio system parameters and usage. This enhances security measures of the phone.

Use Case E: This use case is concerned with balancing processor load in a multiprocessor environment. If one assumes that the underlying hardware resources provide too high a data rate for one radio protocol stack to handle (e.g., future implementations of so-called “gigabit radio”), one solution is to duplicate the protocols and run them on separate processors, and then timeshare the hardware resources. In this case the application's data stream is divided between these multiple radio system instances, and at some point is recombined into a single effective stream.

The implementation of the multiradio system to accommodate these and other use cases is straightforward in the SDR context in accordance with the exemplary embodiments described in PCT/IB2008/055522.

First, an explanation is provided of how the radio stacks are implemented in the SDR system, followed by an explanation of the use of the exemplary embodiments described in PCT/IB2008/055522.

RF signal chains may be designed for substantial reconfiguration so that hardware elements may support a plurality of radio standards. However, there are also RF elements that do not readily support multiple configurations. Typical examples of such components include RF frontend filters and power amplifiers. However, with a suitable software abstraction layer in their control interface, the details of different configurations can be hidden from the higher layer protocols, so that any supported radio protocol can connect to the RF resources and use them. The same kind of arrangement is possible with the digital baseband function. Together, the RF and baseband functions are assumed to comprise the physical (PHY) layer.

FIG. 1 illustrates an exemplary class diagram of radio access stacks and a MRC in the SDR context, where the MRC schedules the access of the radio protocol to the physical resources (PHY layer hardware and radio spectrum). More specifically, FIG. 1 shows an embodiment of a SDR system 10 and an arrangement of a MRC 12, radio Protocols 14 and the PHY 16, and further shows the decoupling of the radio Protocols 14 from the PHY 16. UML (Unified Modeling Language) notation may be used (as shown in FIG. 1, as well as in FIGS. 2-5). There may be multiple radio Protocols 14 that can be instantiated (i.e., activated), and multiple PHY 16 resource elements that support one or more radio standards. The MRC 12 basically schedules spectral resources. Due to the nature of RF, these are implicitly scheduled with the spectral access. The baseband (even if part of the PHY 16), need not necessarily be scheduled by the MRC 12 (in contrast to conventional MRC operation.)

FIG. 2 shows the SDR system 10 at a time when a GSM radio stack is instantiated, i.e., activated and ready for use (the radio Protocols 14 implement GSM protocols). There is a single PHY 16 part for the GSM operation, and a single radio Protocols 14 part to contain the behavior and parameters of the GSM stack. The MRC 12 is also instantiated, although in the given case of the single GSM radio stack its functionality is not particularly relevant.

An implementation of one of the exemplary use cases (Use Case A) is illustrated in FIG. 3 in accordance with the exemplary embodiments described in PCT/IB2008/055522. In this example two GSM Protocol stacks 14A and 14B are instantiated. It is assumed that there are no additional Physical resources 16 for the second GSM Protocol stack 14B, and both an original GSM Protocol stack 14A and a new (newly instantiated) GSM Protocol stack 14B share the same PHY resources 16. In this case one function of the MRC 12 is to regulate accesses to the PHY resources 16, via MRC control paths 12A, 12B, by the GSM Protocol stack 14A and the GSM Protocol stack 14B, respectively.

In general, the Protocol stack 14 may be implemented as computer executable software. As such, and in accordance with an aspect of the embodiments described in PCT/IB2008/055522, it is possible to duplicate the executable software and run it on two or more processors (or processor cores (execution units)), or on one processor if the processor has sufficient processing power.

It may be preferred that the software that implements the Protocol stacks 14 is designed to be reentrant (or thread safe). While this may present an approach that is currently deemed optimal, the implementation of the exemplary embodiments described in PCT/IB2008/055522 does not require the use of re-entrant code, and other approaches may be attempted by those having skill in the art. By the use of re-entrant code it becomes possible to share program code between the multiple instances of the Protocol stacks 14.

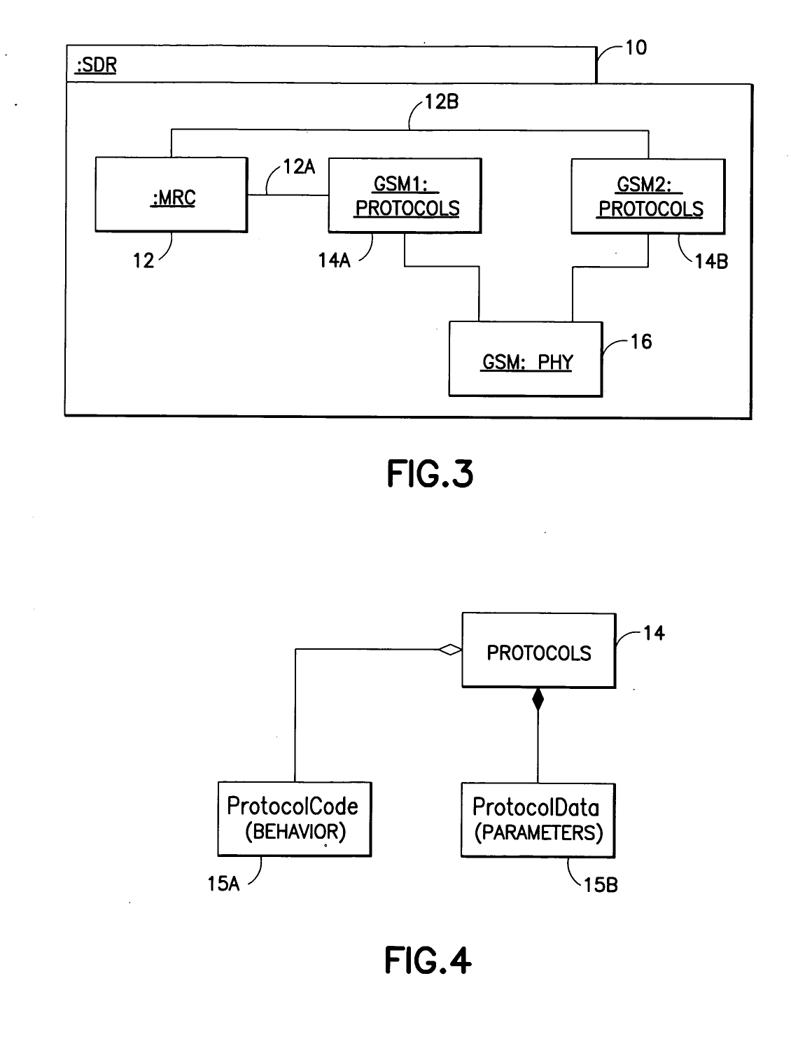

In fact, with reentrant code there is only a need to duplicate the data area of the Protocol stack 14 when multiple instances are created so that each instance of the program code has an associated data area. Further, the behavioral part (program code) need be present in program memory but once. This principle is illustrated in FIG. 4 and FIG. 5. This technique decreases the memory requirements somewhat, as the executable code portion of the multiple radio protocol instances need be present but once in the memory.

More specifically, FIG. 4 depicts a class diagram showing the division of a Protocol stack 14 into a behavioral part 15A (program code) and a data part 15B (e.g., typically radio parameters). Upon a certain Protocol class being instantiated (the program code 15A) it is assumed to automatically contain its associated data (data part 15B). Thus, separate instances of Protocol stacks 14 may each have associated and separate data area. The Protocol code 15A is, however, instantiated only once for each radio system.

FIG. 5 is an exemplary object diagram showing the protocols-related instances of classes in the SDR system, at one time, for the example of FIG. 3. In this case both the original GSM Protocol stack 14A and the new GSM Protocol stack 14B operate from the same GSM Protocol Code 15A (which is assumed to be re-entrant and thread-safe), and each of the original GSM Protocol stack 14A and the new GSM Protocol stack 14B has an associated and separate Protocol data part 15B1 and 15B2, respectively.

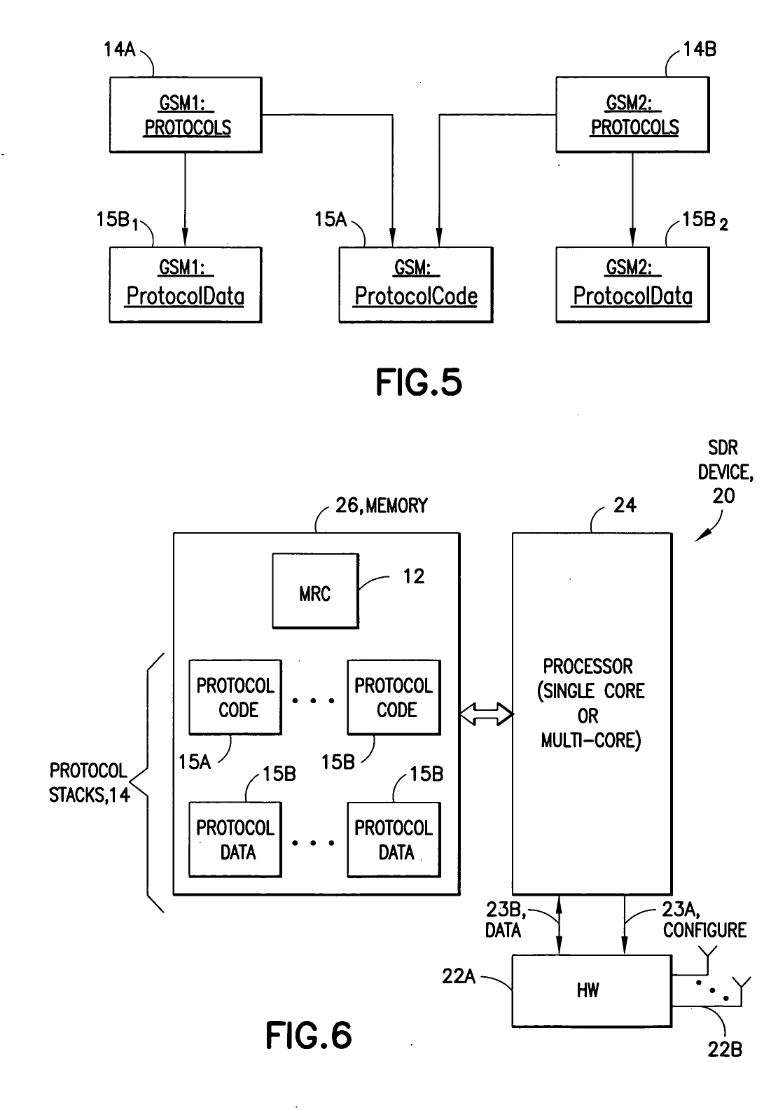

FIG. 6 depicts an exemplary embodiment of a SDR device 20, such as a multimode cellular phone or other type of communication device. A hardware (HW) block 22A includes RF and other circuitry for supporting reception and transmission of wireless communication signals via one or more antennas 22B. In certain embodiments the HW block 22A may contain only that circuitry that is not efficiently implemented or emulated by program code running on at least one processor 24. In other embodiments all of the necessary RF front end and other circuitry (e.g., at least certain baseband circuitry) that is needed may be physically present in the HW block 22A. The HW block 22A is interfaced with the processor 24 using at least a configuration bus 23A, whereby the processor 24 is enabled to configure, program and select certain RF and other circuitry for use, as well as using a data bus 23B where the data (information) to be transmitted and that is received passes.

The at least one processor 24 may be a single-core or a multi-core processor that is coupled with a memory 26. In a single core processor 24 embodiment there may be a scheduler present for scheduling the execution of code, such as when time-slicing the processor execution of a plurality of software modules stored in the memory 26. In a multi-core embodiment each processor core may be capable of the simultaneous execution of a separate software module, and/or capable of simultaneously processing the same software module, depending on need. The software modules of most interest are a software module that implements the MRC 12 functionality, and software modules that implement the radio Protocol stack or stacks 14. In this case there may be multiple instances of different radio Protocol stacks 14 (e.g., a GSM stack and an E-UTRAN (evolved universal terrestrial radio access network, also referred to as LTE (long term evolution)) stack, or a GSM stack and a WLAN stack), or multiple instances of the same type of radio Protocol stack (as a non-limiting example, multiple instances of the GSM Protocol stack as shown in FIGS. 3 and 5, or multiple instances of an E-UTRAN Protocol stack, or multiple instances of an HSDPA Protocol stack, as non-limiting examples). In the latter case the memory 26 may contain only one instance of the Protocol code 15A, and multiple instances of the Protocol data 15B, as was shown in FIG. 5.

The MRC 12 is assumed to be capable of overall control and management of the operation of the processor 24 as it pertains to the radio Protocol stack(s) 14, and to be capable of instantiating additional instances of the same, or different, radio Protocol stacks 14 as needed (e.g., to satisfy the various use cases discussed above, as well as others).

Note that the embodiment shown in FIG. 6 is not intended to be limiting in any manner. For example, in a multi-core processor 24 embodiment (multi-execution unit processor) each processor core may have its own associated program and data memory, and may or may not also interface to a common memory. Further, the memory 26 may not be a separate block per se, but may be integrated with the processor block 24 (as may also some or all of the HW 22A) into a single integrated circuit or module. Further, it should be appreciated that the memory block 26 may also include the memory disposed on one (or more than one) removable SIM, or in one SIM storing multiple user identities or subscriptions, as non-limiting examples.

Further, it should be noted that in some embodiments described in PCT/IB2008/055522 it may be desirable to implement the SDR 10 as an array of digital signal processors, custom logic blocks and/or vector processors. In general, a vector processor may be considered to be a computer that can perform an operation on an array of numbers in a single step, and may also be referred to as an array processor. Vector processors may be a preferred hardware embodiment for SDR baseband signal processing implementations. By the use of an array of vector processors a new set of algorithms can be loaded to support a new/different radio system. The multiple instances of a radio protocol that share the processing time of a vector processor, or a digital signal processor, would do so in a manner similar as to how they would share a custom logic block. In the exemplary embodiments described in PCT/IB2008/055522 any needed signal processing may be done in the HW 22A using any suitable type or types of components including logic blocks, digital signal processors and/or vector processors, as non-limiting examples.

As can be appreciated, creating multiple instances of radio systems allows for many significant and useful embodiments to be realized, while not increasing the complexity of the SDR system and device 20.

In one aspect thereof the exemplary embodiments described in PCT/IB2008/055522 provide the SDR radio device 20 with multiple instances of a single radio Protocol stack 14 that are enabled to use the same RF resources (HW 22A). The behavior of the various protocol stacks are “summed” at a connector of the antenna or antennas 22B.

The exemplary embodiments described in PCT/IB2008/055522 may be used to advantage in a multiple SIM user terminal having two or more subscriber connections active (at least participating to the network, and waiting for an incoming call or message) at the same time. The exemplary embodiments are also useful when implementing cognitive radio applications and devices.

The exemplary embodiments described in PCT/IB2008/055522 provide an ability to instantiate multiple instances of the same radio (radio Protocol 14) and thereafter divide, if desired, the traffic between the multiple instantiations, or to use each instantiation separately.

The exemplary embodiments described in PCT/IB2008/055522 further provide an apparatus that includes a memory; a hardware unit embodying a physical layer; and a controller configured to instantiate a plurality of the radio protocols and to operate the plurality of radio protocols with the hardware unit, where each instantiation of a same radio protocol is embodied in a same code module and with associated data stored in the memory. The controller is further configured to execute each instantiation of a radio protocol so that a portion of resources are shared between different instantiations of radio protocols, and different instantiations of radio protocols do not interfere with each other.

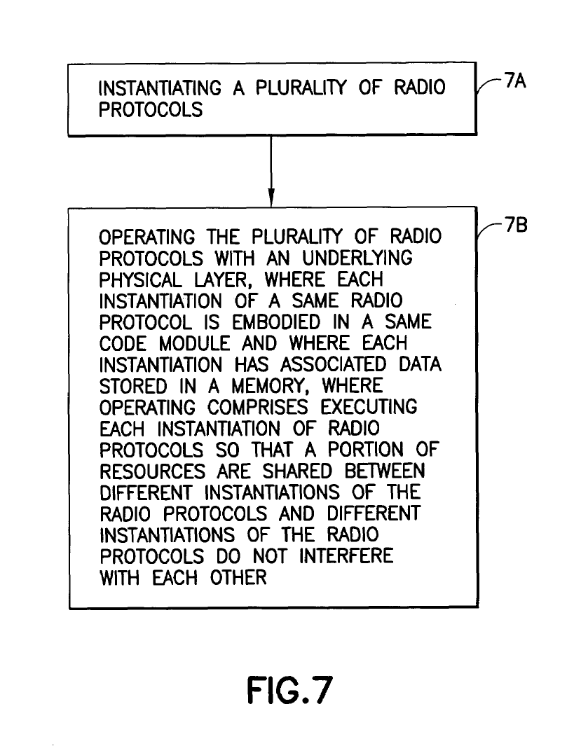

Based on the foregoing it should be apparent that the exemplary embodiments described in PCT/IB2008/055522 provide a method, apparatus and computer program to enhance the operation of a software defined radio that include a multiradio controller. Referring to FIG. 7, at Block 7A there is performed a step of instantiating a plurality of radio Protocols, and at Block 7B operating the plurality of radio Protocols with an underlying physical layer where each instantiation of the same radio protocol is embodied in the same code module and each instantiation has associated data stored in a memory. At Block 7B, the operating of the plurality of radio Protocols comprises executing each instantiation of the radio protocols so that a portion of resources are shared between different instantiations of the radio protocols and different instantiations of radio protocols do not interfere with each other.

As was discussed above, in SDR the radio systems may be realized using software components running on different types of processors (general purpose, signal processing, vector processing), in addition to suitable hardware components to implement those functions that cannot be implemented with software, or where a software implementation would be inefficient.

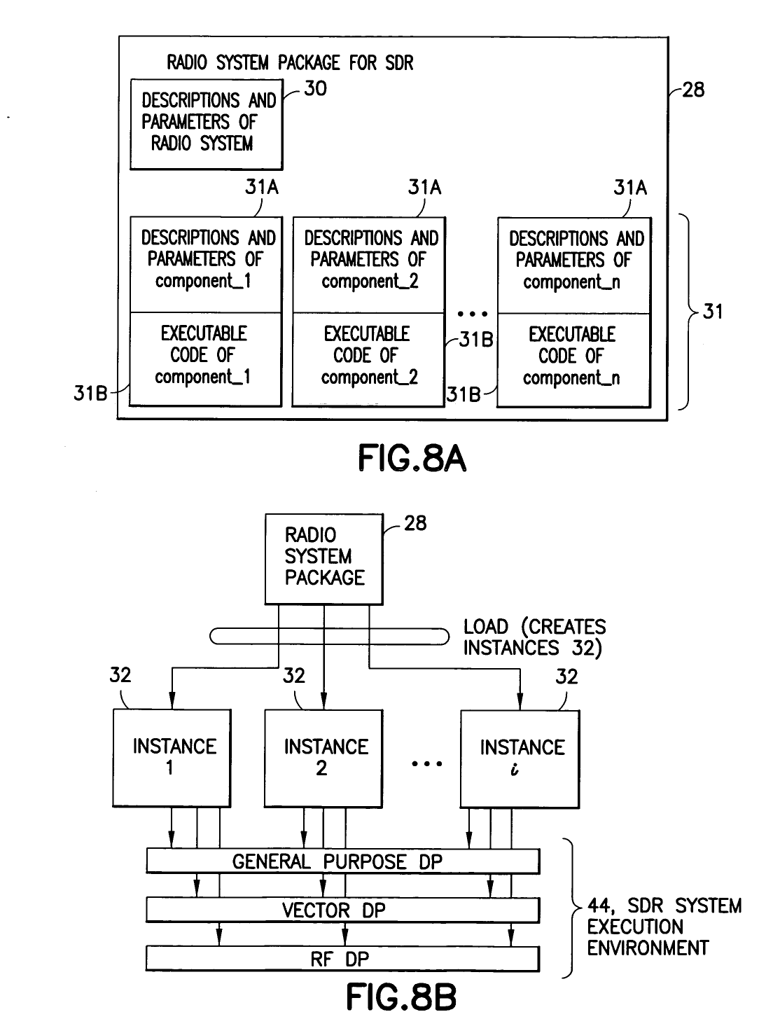

Referring to FIG. 8A, a radio system is installed into a SDR system 10 as a radio system package 28 that contains all necessary executable software components, their descriptions and parameters. FIG. 8B shows an example of the creation (by a load operation) of i radio system instances 32 from the radio system package 28 of FIG. 8A, where i can be equal to one or more.

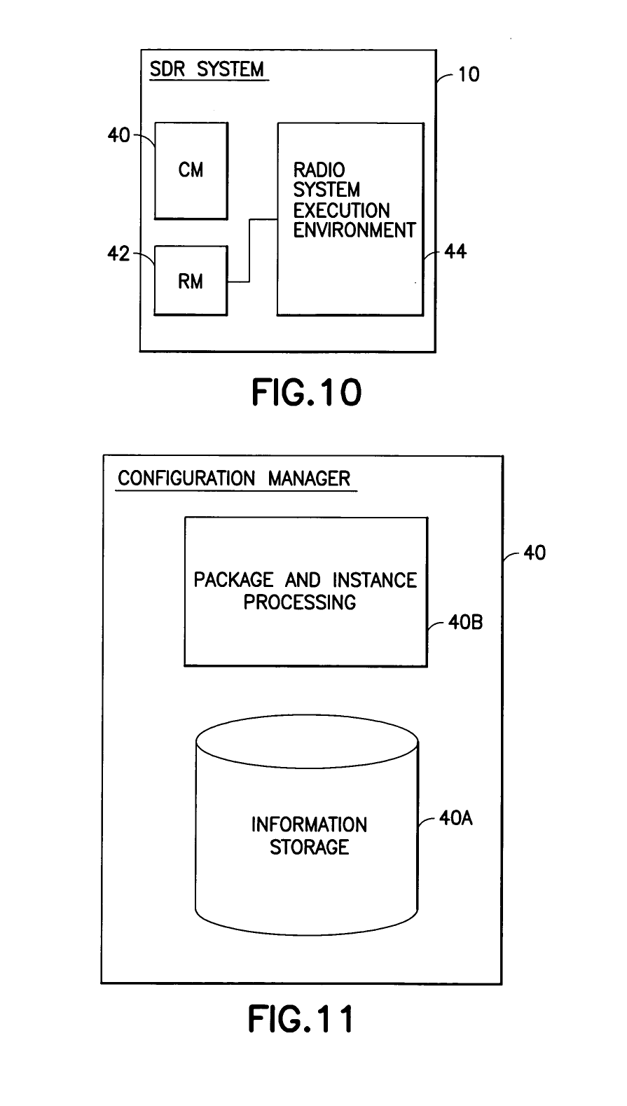

The components 31 (components 1-n) in FIG. 8A represent the fact that in reality a radio implementation is typically divided into parts (i.e., into ‘components’) that execute in different parts of the SDR device 20. As a non-limiting example, and referring also to FIG. 8B, there may be a component 31 (e.g., component_1) that executes in a general purpose processor or data processor (DP) environment, a component 31 (e.g., component_2) that executes in a vector data processor environment, and possibly a component 31 (e.g., component_n) that executes in a RF processor environment. The various non-limiting examples of the data processors shown in FIG. 8B (general purpose, vector, RF) together comprise a part of what is referred to below in relation to FIG. 10 as the system execution environment (or platform) 44. Each component 31 comprises a component-specific descriptions and parameters portion 31A and a component-specific executable code portion 31B. The code portions 31B of the plurality of components 31 together form what in FIG. 4 is referred as Protocol code (Behavior) 15A. The block 30 in FIG. 8A contains those descriptions and parameters that are not component-specific. The block 30 and the blocks 31A together generally refer to the same data that is referenced as Protocol data (Parameters) 15B in FIG. 4 (note that this block 15B in FIG. 4 may also contain data created during execution, which may or may not be the case for the embodiment shown in FIG. 8A).

To execute such a radio system package 28 as the multiple instances 32, each instance 32 is first loaded to the execution platform and the instance 32 obtains its own copy of the radio system parameters (blocks 30, 31A) and the executable code (blocks 31B). Each loaded radio system instance 32 is activated and the end result is simultaneously executing instances of a same radio system, as described as a non-limiting example in PCT/IB2008/055522.

A given radio system package 28 is thus assumed to incorporate program instructions and data structures designed to implement a particular type of radio system, as defined by the applicable standardization document or documents, e.g., 3GPP or IEEE standardization documents. For example, one radio system of interest in this regard is generally described by 3GPP TS 36.300, V8.7.0 (2008-12), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8). This system may be referred to for convenience as LTE Rel-8, or simply as Rel-8. In general, the set of specifications given generally as 3GPP TS 36.xyz (e.g., 36.211, 36.311, 36.312, etc.) may be seen as describing the entire Release 8 LTE system. Further enhancements to the Rel-8 LTE system (LTE-Advanced or LTE-A) are also of interest. Further by example, the set of specifications given generally as 3GPP TS 44.xyz and 3GPP TS 45.xyz may be seen as generally describing the GSM, GSM/EDGE system, while the various specifications generally given by IEEE 802.16 and 802.16x may be seen as generally describing various broadband wireless access systems. In a particular implementation a given radio system package 28 may be pre-installed in the SDR device 20. In another implementation a given radio system package 28 may be installed in the SDR device 20 by inserting a memory device, such as one contained in a SIM or a SIM-like component. In another implementation a given radio system package 28 may be installed in the SDR device 20 by the use of over-the-air (OTA) programming, or by a wired download connection through the internet or some other data communications network. In some implementations all of these techniques (as well as others) may be used to install multiple radio system packages 28 so that they are simultaneously resident within the SDR device 20 and thus can be used, in accordance with the exemplary embodiments of this invention, to create instantiations of one or more instances of each radio system package 28 in turn or together. Note that a particular radio system package 28, once installed, may remain installed (resident) in the SDR device 20 whether there are instances of the radio system package 28 in use or not. Alternatively, a given radio system package 28 may be un-installed (removed/deleted) when not in use, possible to conserve memory space or for any suitable reason.

As was noted with respect to FIGS. 4 and 5, it may also be the case in FIG. 8B that two or more of the instances 32 share one or more code portions 31B. Furthermore, it is possible to share code between radio instances 32 of different radio system packages 28, assuming that a configuration manager (CM) 40, a resource manager (RM) 42 and an execution environment 44 (see FIG. 10 and the discussion of same below) support such functionality. As one non-limiting example, different radio systems may share common baseband processing algorithms and, thus, only one copy of the baseband algorithm code needs to be loaded. This embodiment may be similar to that described previously with regards to sharing protocol code between instances 32, for example, the shared code (e.g., shared baseband processing code) is designed to be re-entrant.

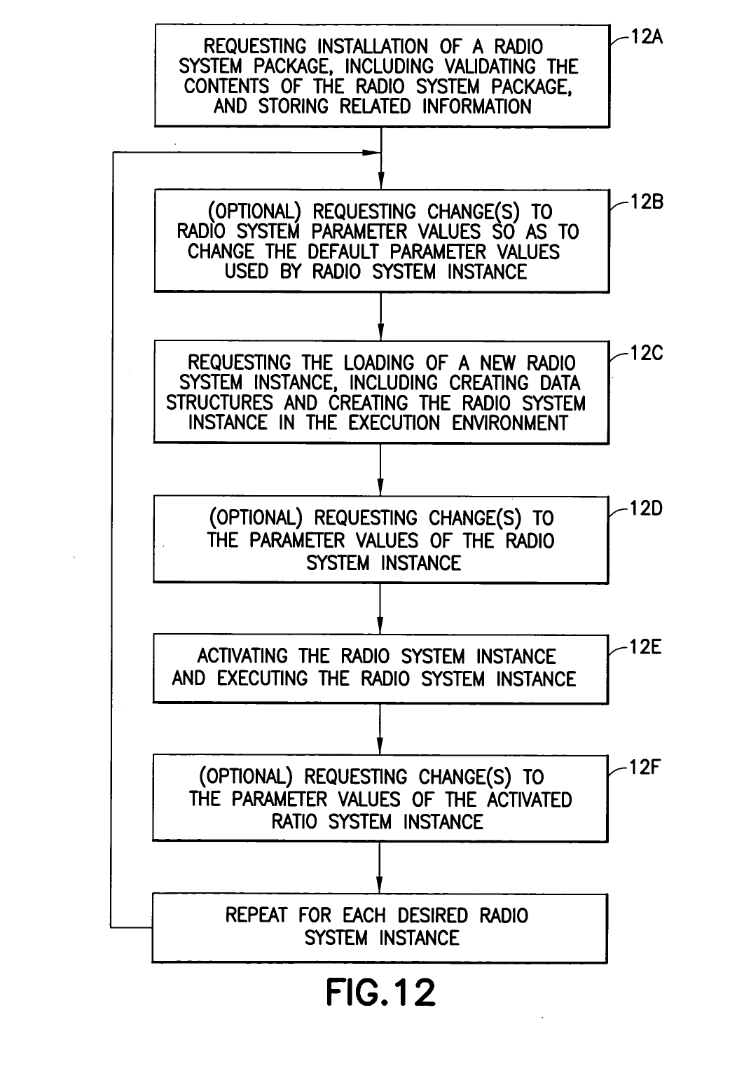

The radio system parameters can be modified during the life cycle of a radio system and its instances with different results. For example, in one case when radio system parameters (e.g., 30 and/or 31A) of an installed radio system package 28 are modified (e.g., see Block 12B of FIG. 12) the modified parameter values become the initial parameter values of the subsequently loaded radio system instance or instances 32. In another case, when the radio system parameters of a loaded radio system instance 32 are modified (e.g., see Block 12D of FIG. 12), the modified parameter values are placed into use when that particular radio system instance 32 is activated. The radio system package 28 and other loaded or active radio system instances 32 are not affected in this case. In yet another case, when the radio system parameters of an active radio system instance 32 are modified (e.g., see Block 12F of FIG. 12), the modified parameter values may change the behavior of the instance. The radio system package 28 and other loaded or active radio system instances 32 are not affected.

This procedure of installing a radio system package 28 and loading and executing instances 32 of the radio system package 28 is also applicable when a single instance 32 of a particular radio system package 28 is used.

From the perspective of the exemplary embodiments of this invention the SDR system 10 may be partitioned into the components shown in FIG. 10. A configuration manager (CM) 40 contains processing capability and storage capability related to the handling of the radio system package 28 and the associated instance(s) 32. A resource manager (RM) 42 contains at least processing capability for reserving and allocating resources for radio system instances 32, and creates the executable radio system instance(s) 32 within the radio system execution environment 44. The radio system execution environment 44 may be assumed to contain all needed software and hardware to execute a particular radio system package 28 in the form of the one or more radio system instances 32. The execution environment 44 may also contain processing elements/units common to all radio system instances 32. For example, the multiradio controller (MRC) that schedules access to the air interface may reside within the radio system execution environment 44. The CM 40 and RM 42 may use in their implementation the same software and hardware resources as the radio system execution environment 44, or they may execute in their own hardware and software environment. It should be noted that FIG. 10 is intended to depict the logical division of processing responsibilities, and not necessarily how the hardware/software is physically partitioned.

In general, the CM 40, RM 42 and the execution environment 44 of FIG. 10 may be embodied in FIG. 6 within memory 26, where the MRC 12, Protocol code 15A and Protocol data 15B may exist within the execution environment 44. The CM 40, RM 42 from FIG. 10 may also be included in FIG. 1 within the SDR 10, with the MRC 12, Protocols 14 and PHY 16.

The CM 40 can further be partitioned into the components shown in FIG. 11. An information storage 40A provides storage of the contents of installed radio system package(s) 28, as well as storage of relevant information of the radio system instances 32 (e.g., at least their state and the related parameters). A package and instance processing unit 40B controls interaction with a user or users of the SDR system 10. Note that the CM 40 provides user services such as, but not limited to, installing a radio system package or packages 28, loading (creating) the instance or instances 32 thereof, activating the loaded instance or instances 32, and writing parameter values and other related and similar tasks as needed.

It should be noted that in this context references to a “user” of the SDR system 10 refer to an entity above the SDR system that requests services from the SDR system. In some cases the user may be a human user, while typically it is the case that the user is a software package/application that detects that, in order to fulfill a particular goal, a change in the radio communication environment is needed.

The package and instance processing unit 40B may also controls interaction with the other parts of the SDR system 10. The CM 40, for example, requests the RM 42 to perform the necessary processing to create the instances 32 of radio systems into the execution environment 44. The CM 40 also provides, for example, a service to access parameter values in the information storage 40A for radio system instances 32 that are executing. The CM 40, in cooperation with the package and instance processing unit 40B, also performs checks that ensure that only allowed state transitions are executed. For example, it is not possible to active a radio system instance 32 that has not been loaded (created).

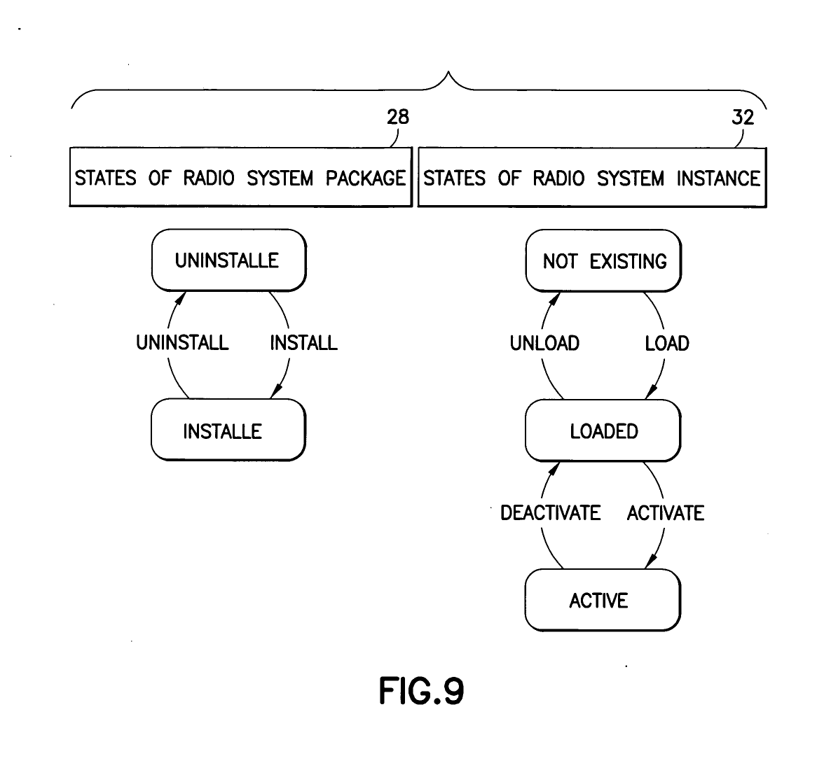

The states of the radio system package 28 and its instances 32 during their life times (‘life-cycles’) are presented in FIG. 9. The definitions of the states of the radio system package 28 shown in FIG. 9 are:

a) uninstalled: a radio system package 28 is not known to the SDR system 10; and

b) installed: a radio system package 28 is controlled by the SDR system 10, all relevant information is stored in memory, such as databases that may reside in the information storage 40A, and radio system instance creation is possible.

The definitions of the radio system instance 32 states shown in FIG. 9 are:

a) not-existing: the radio system instance 32 does not exist;

b) loaded: the radio system instance 32 exists (has been created), and resources may have been reserved and allocated, but the instance 32 does not yet execute radio system behavior; and

c) active: the radio system instance has all needed resources reserved and allocated, and executes the radio system behavior.

The transitions between the uninstalled and the installed states are uninstall and install, the transitions between the not-existing and the loaded states are unload and load, while the transitions between the loaded and active states are deactivate and activate.

The actual implementation of the information storage 40A may be, in one exemplary and non-limiting embodiment, a set of files stored on a file system or, in another exemplary embodiment, a database system (e.g., a relational database or similar type of database system). In mobile devices the implementation may be hybrid of these two approaches, e.g., a combination of files on a file system and a database based on the exact requirements of the device. The information storage 40A is assumed to be persistent at least for the radio system package 28 information, that is, the information of installed radio system packages 28 is assumed to be available after the SDR system 10 is powered down and then powered up again. Examples of persistent storage include, but are not limited to, flash memory, battery-backed RAM and disk memory.

It should be noted the functionality of the SDR system 10, including the CM 40, the RM 42 and the execution environment 44 may be incorporated into the SDR device 20 that was described above in relation to FIG. 6. In this case the at least one processor 24, and software running on the at least one processor 24, can embody radio system package(s) 28 and the various instantiations thereof. The package and instance processing unit 40B may be resident in the memory (information storage 40A) from where the one or more processors 24 execute same, and the information storage 40A may be configured as read/write memory (at least a portion of which may be persistent memory) connected with the at least one processor 24, and thus may be seen to embody a computer-readable memory that stores in part program instructions executable by the at least one processor 24.

Steps/procedures to create radio system instances 32 in this type of environment are shown in FIG. 12. As was noted above, in this context references to a “user” of the SDR system refer to any suitable entity above the SDR system that requests services from the SDR system.

Block 12A: A user of the SDR system 10 requests installation of a radio system package 28. The CM 40 validates the contents of a provided radio system package 28 and the information is stored in the information storage 40A within the CM 40. As was noted above, the radio system package 28 may be provided in any of a number of suitable manners, such as by installing a memory device or by OTA programming.

Block 12B: The user of the SDR system 10 may request changes to the radio system parameter values so as to change the default parameter values that new radio system instances 32 will use.

Block 12C: The user of SDR system 10 requests the loading of a new radio system instance 32. The CM 40 creates the necessary data structures in the information storage 40A for a new radio system instance 32 (at least a state of the instance and a copy of the parameters and their values from the radio system package 28). The CM 40 also requests the RM 42 to create the radio system instance 32 in the execution environment 44.

Block 12D: The user of the SDR system 10 may request changes to the parameter values of the radio system instance if the default parameters values copied are not suitable for the requested instance 32.

Block 12E: The user of the SDR system 10 requests activation of the radio system instance 32. The CM 40 activates the radio system instance 32 and the radio system instance begins execution.

Block 12F: The user of the SDR system 10 may request changes to the parameter values of the activated and executing radio system instance 32.

The operations shown in Blocks 12B-12F are repeated for each desired radio system instance 32. Note that the processing order may be modified so that, for example, all requested radio system instances 32 are first loaded, their parameters are modified (Blocks 12C, 12D) after which each radio system instance 32 is activated (Block 12E). The user may then execute Block 12F for one or more of the activated radio system instances 32 so as to modify one or more parameters thereof.

One non-limiting example of a parameter that may be changed in either of Blocks 12B, 12D, or 12F is a WLAN channel number (e.g., to operate with a desired channel as opposed to a default channel).

When a radio system instance 32 is deactivated, unloaded and possibly the radio system package 28 is uninstalled the steps above are done in reverse order so that, eventually, there may be no trace of a particular radio system remaining in the SDR system 10. The CM 40 may also comprise processing that allows, for example, a user of the SDR system 10 to request de-installation (un-install) of a radio system package 28 that has already loaded and active radio system instances 32 associated therewith. In such a case the CM 40 may first deactivate all active instances 32, unload all of the deactivated instances 32, and then perform the de-installation of a radio system package 28.

There are a number of alternative embodiments for creating multiple instances of a radio system.

For example, in one exemplary alternative embodiment a duplicate radio system package 28 is created and assigned unique identification information. The CM 40 handles the life-cycle (‘uninstalled-installed-loaded-active’) for each radio system package 28. In this case each radio system instance 32 is handed effectively as a unique radio system.

As another example, there may be a radio system package 28 with a life-cycle of ‘uninstalled-installed-loaded’ and a radio system instance 32 with a life-cycle of ‘inactive-active’. In this case there may be some latency in the activation of a radio instance as per-instance structure creation and resource allocations are performed at activation time. As the radio system instance parameter values exist only as long as the instance 32 is active, there may be a need for more requests to the set of parameter values than in the more preferred approach described above.

As a further example, the parameter values for radio system instances 32 may be included in the load and/or activate requests from the user of the SDR 10.

Creating the multiple instances 32 of the radio system package(s) 28 provides numerous advantages while not increasing the complexity of the SDR system 10.

Note that the steps used to create multiple instances of a radio system may also be used to create a single instance of the radio system.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of this invention also provide an apparatus that comprises means for installing a radio system package and means, responsive to a first request, for loading a new radio system instance of the installed radio system package and, responsive to a second request, for activating the loaded radio system instance and executing the loaded radio system instance.

It should be appreciated that at least some aspects of the exemplary embodiments of the inventions may be practiced in various components such as integrated circuit chips and modules.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the IEEE 802.11, IEEE 802.16, GSM, HSDPA and EUTRAN (UTRAN-LTE) systems, it should be appreciated that the exemplary embodiments of this invention are not limited for use with only these particular types of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
installing a radio system package;
in response to a first request, loading a new radio system instance of the installed radio system package; and
in response to a second request, activating the loaded radio system instance and executing the loaded radio system instance.

2. The method of claim 1, where installing comprises validating contents of the radio system package, and storing related information.

3. The method as in claim 1, further comprising changing radio system parameter values of the radio system package so as to change default parameter values used by a subsequently loaded radio system instance.

4. The method as in claim 1, further comprising changing radio system parameter values of one or both of a loaded radio system instance and an activated radio system instance.

5. The method as in claim 1, where loading a new radio system instance comprises creating data structures associated with the radio system instance and creating the radio system instance in an execution environment.

6. The method as in claim 1, further comprising repeating the steps of loading and activating a plurality of times to load and activate a plurality of radio system instances of the same radio system package, where two of the activated radio system instances operate with one of the same parameter values or different parameter values.

7. The method as in claim 1, where the radio system package, at any given time, is in one of at least two states, comprising an uninstalled state and an installed state, and where the step of installing transitions the radio system package from the uninstalled state to the installed state, and further comprising a step of transitioning the radio system package from the installed state to the uninstalled state, where the step of transitioning the radio system package from the installed state to the uninstalled state comprises first deactivating any activated instances of the radio system package.

8. The method as in claim 1, where the radio system instance, at any given time, is in one of at least three states, comprising a not existing state, a loaded state and an active state, where the step of loading transitions the radio system instance from the not existing state to the loaded state, and where the step of activating transitions the radio system instance from the loaded state to the active state, and further comprising transitioning the radio system instance from the active state to the loaded state, and from the loaded state to the not existing state.

9. The method as in claim 1, where executing executes a plurality of radio system instances of the same radio system package or different radio system packages with an underlying physical layer so that a portion of physical layer resources are shared in a non-interfering manner between the radio system instances.

10. A memory storing a program of computer readable instructions that when executed by a processor result in actions that comprise:
installing a radio system package;
in response to a first request, loading a new radio system instance of the installed radio system package; and in response to a second request, activating the loaded radio system instance and executing the loaded radio system instance.

11. The memory of claim 10, where installing comprises validating contents of the radio system package, and storing related information, and where loading a new radio system instance comprises creating data structures associated with the radio system instance and creating the radio system instance in an execution environment.

12. The memory as in claim 10, further comprising at least one of changing radio system parameter values of the radio system package so as to change default parameter values used by a subsequently loaded radio system instance, and changing radio system parameter values of one or both of a loaded radio system instance and an activated radio system instance.

13. The memory as in claim 10, further comprising repeating the operations of loading and activating a plurality of times to load and activate a plurality of radio system instances of the same radio system package, where two of the activated radio system instances operate with one of the same parameter values or different parameter values.

14. The memory as in claim 10, where the radio system package, at any given time, is in one of at least two states, comprising an uninstalled state and an installed state, and where the operation of installing transitions the radio system package from the uninstalled state to the installed state, and further comprising an operation of transitioning the radio system package from the installed state to the uninstalled state, where the transitioning operation of the radio system package from the installed state to the uninstalled state comprises first deactivating any activated instances of the radio system package.

15. The memory as in claim 10, where the radio system instance, at any given time, is in one of at least three states, comprising a not existing state, a loaded state and an active state, where the step of loading transitions the radio system instance from the not existing state to the loaded state, and where the operation of activating transitions the radio system instance from the loaded state to the active state, and further comprising an operation of transitioning the radio system instance from the active state to the loaded state, and from the loaded state to the not existing state.

16. The memory as in claim 10, where the operation of executing executes a plurality of radio system instances of the same radio system package or different radio system packages with an underlying physical layer so that a portion of physical layer resources are shared in a non-interfering manner between the radio system instances.

17. An apparatus comprising:
a memory;
a hardware unit embodying at least a portion of a radio physical layer; and
a controller configured to install a radio system package into said memory, to respond to a first request to load a new radio system instance of the installed radio system package and to respond to a second request to activate the loaded radio system instance and to execute the loaded radio system instance using said hardware unit.

18. The apparatus as in claim 17, where said controller is further configured to load and execute a plurality of radio system instances of the same radio system package or different radio system packages with said hardware unit so that a portion of physical layer resources are shared in a non-interfering manner between the radio system instances.

19. The apparatus according to claim 17, embodied at least partially as an integrated circuit in a wireless communication device, where said hardware unit comprises a plurality of processors each configured to execute associated code in conjunction with associated parameters that together comprise part of said radio system package.
